(19) United States
(12) Patent Application Publication
(10) Pub. No.: US 2020/0039871 A1
(43) Pub. Date: Feb. 6, 2020

(54) METHODS FOR REDUCING GLASS SHEET EDGE PARTICLES

(71) Applicant: Corning Incorporated, Corning, NY (US)

(72) Inventors: Tsen Jen Chen, Taipei City (TW); Jia Liu, Painted Post, NY (US); Siva Venkatachalam, Elmira, NY (US); Hui Chien Wu, Taichung-si (TW); Jing Zhao, San Diego, CA (US)

(21) Appl. No.: 16/482,571

(22) PCT Filed: Jan. 31, 2018
(86) PCT No.: PCT/US2018/016124

§ 371 Date: Jul. 31, 2019

Related U.S. Application Data
(60) Provisional application No. 62/452,689, filed on Jan. 31, 2017.

(51) Int. Cl. C03C 15/00

(52) U.S. Cl. CPC C03C 15/00

(57) ABSTRACT

A method of manufacturing a glass article includes application of an etch solution to an edge surface of the article. Application of the etch solution can reduce a density of particles on the edge surface to less than about 200 per 0.1 square millimeter. The etch solution can, for example, contain hydrofluoric acid and hydrochloric acid.

This application claims the benefit of priority under 35 U.S.C. § 119 of U.S. Provisional Application Ser. No. 62/452,689 filed on Jan. 31, 2017, the contents of which are relied upon and incorporated herein by reference in their entirety as if fully set forth below.

### FIELD

The present disclosure relates generally to methods for manufacturing glass articles and more particularly to methods for reducing glass sheet edge particles in the manufacture of glass articles.

### BACKGROUND

In the production of glass articles, such as glass sheets for display applications, including televisions and hand held devices, such as telephones and tablets, the glass articles must meet increasingly stringent requirements for surface contamination, specifically substantially low levels of, for example, organic stains dust, and glass particles on the surfaces of the articles. These increasingly stringent requirements have, for example, been driven by increasing resolution levels of display devices, which, with ever decreasing pixel sizes, are increasingly sensitive to particles.

During the production of glass articles there are many processing steps during which, for example, glass and dust particles may adhere to not only the surfaces but also the edges of glass sheets. While much attention has been given to reducing the number of particles on the surfaces of glass sheets, relatively less attention has been given to reducing the number of particles on the edges of glass sheets.

As particles may migrate from the edges to the surfaces of glass sheets, recent efforts have focused on mechanical methods for reducing edge particles, such as edge cleaning wheels. However, such mechanical methods may only remove existing particles, while further particles may be generated due to effects of downstream processing steps on edge surface topography. Accordingly, it would be desirable to develop edge cleaning methods that not only address removal of existing particles but also mitigate the further generation of particles as the result of downstream processing steps.

### SUMMARY

Embodiments disclosed herein include a method for manufacturing a glass article. The method includes forming the glass article. The glass article includes a first major surface, a second major surface parallel to the first major surface, and an edge surface extending between the first major surface and the second major surface in a perpendicular direction to the first and second major surfaces. The method also includes applying an etch solution to the edge surface of the glass article, wherein application of the etch solution reduces a density of particles on the edge surface to less than about 200 per 0.1 square millimeter.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is an perspective view of a glass sheet;

FIG. 3 is a perspective view of at least a portion of a beveling process of an edge surface of a glass sheet;

FIG. 4 shows cross-sectional scanning electron microscope (SEM) images of glass samples treated with an etch solution for varying amounts of time;

FIG. 5 shows a cross-sectional SEM image of a glass sample treated with an etch solution;

FIG. 6 shows a gel-tack optical microscopy image of a glass sample treated with an etch solution; and

FIG. 7 shows a gel-tack optical microscopy image of a glass sample treated with an etch solution.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

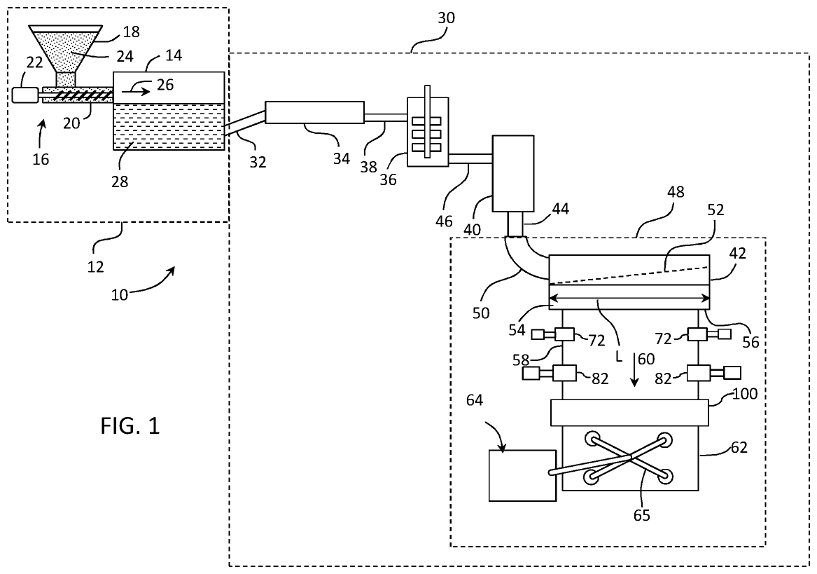

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process, or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example in examples, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

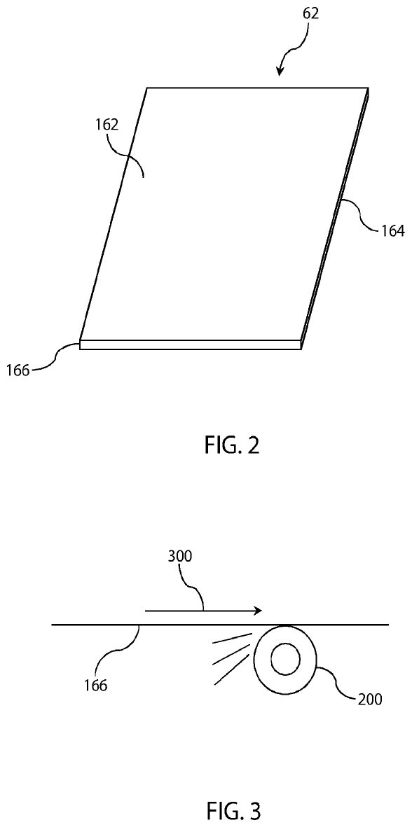

FIG. 2 shows a perspective view of a glass sheet 62 having a first major surface 162, a second major surface 164 extending in a generally parallel direction to the first major surface (on the opposite side of the glass sheet 62 as the first major surface) and an edge surface 166 extending between the first major surface and the second major surface and extending in a generally perpendicular direction to the first and second major surfaces 162, 164.

FIG. 3 shows a perspective view of at least a portion of a beveling process of an edge surface 166 of a glass sheet 62. As shown in FIG. 3, beveling process includes applying a grinding wheel 200 to edge surface 166, wherein the grinding wheel 200 moves along edge surface 166 in the direction indicated by arrow 300. Beveling process may further include applying at least one polishing wheel (not shown) to edge surface 166. Such beveling process can lead to the presence of numerous glass particles, as well as surface and sub-surface damage (i.e., irregular topography), on edge surface 166.

Downstream processing of glass sheet 62 may involve application of mechanical or chemical treatments on edge surfaces 166, which can result in additional particle generation due to the presence of irregular edge surface topography. Such particles may migrate to at least one surface of glass sheets 62. Accordingly, embodiments disclosed herein include those in which irregular edge surface topography is removed, while at the same time removing edge particles present on the edge surfaces 166 as well as removing reaction by-products that may be formed upon removal of the irregular edge surface topography.

Embodiments disclosed herein include those in which an etch solution is applied to an edge surface 166 of glass sheet 62, including those in which the edge surface 166 is subjected to a beveling process, such as shown in FIG. 3, prior to application of the etch solution. Application of the etch solution can reduce a density of particles on the edge surface to less than about 200 per 0.1 square millimeter, such as less than about 150 per 0.1 square millimeter, and further such as less than about 100 per 0.1 square millimeter, and yet further such as less than about 50 per 0.1 square millimeter, including from about 1 to about 200 per 0.1 square millimeter, and further including from about 10 to about 150 per 0.1 square millimeter, and yet further including from about 20 to about 100 per 0.1 square millimeter.

In certain exemplary embodiments, the etch solution may comprise hydrofluoric acid and hydrochloric acid. For example, in certain exemplary embodiments, the etch solution may be an aqueous solution comprising hydrofluoric and hydrochloric acid.

In certain exemplary embodiments, the etch solution may consist essentially of hydrofluoric and hydrochloric acid. For example, in certain exemplary embodiments, the etch solution may be an aqueous solution consisting essentially of water, hydrofluoric acid, and hydrochloric acid.

In certain exemplary embodiments, the etch solution may be substantially free of organic components, such as organic acids.

When the etch solution contains hydrofluoric acid and hydrochloric acid, the concentration of the hydrochloric acid in the etch solution may, for example, be equal to or greater than the concentration of the hydrofluoric acid in the etch solution, such as at least about twice the concentration of the hydrofluoric acid in the etch solution, and further such as at least about three times the concentration of the hydrofluoric acid in the etch solution, and yet further such as at least about four times the concentration of the hydrofluoric acid in the etch solution, and still yet further such as at least about five times the concentration of the hydrofluoric acid in the etch solution. For example, the concentration ratio of hydrochloric acid to hydrofluoric acid in the etch solution may range from about 1:1 to about 6:1, such as from about 2:1 to about 5:1.

In such embodiments, the concentration of the hydrofluoric acid in the etch solution may be at least about 1.5 molar, such as at least about 2 molar, and further such as at least about 2.5 molar, and yet further such as at least 3 molar. For example, the concentration of hydrofluoric acid in the etch solution may range from about 1.5 to about 6 molar, such as from about 2 to about 4 molar.

Embodiments disclosed herein include those in which the concentration of the hydrochloric acid in the etch solution may be at least about 1.5 molar, such as at least about 3 molar, and further such as at least about 4.5 molar, and yet further such as at least about 6 molar, and still yet further such as at least about 7.5 molar. For example, the concentration of hydrochloric acid in the etch solution may range from about 1.5 to about 12 molar, such as from about 3 to about 12 molar, and further such as from about 4.5 to about 9 molar.

Accordingly, embodiments disclosed herein include those in which the concentration of hydrofluoric acid in the etch solution is at least about 1.5 molar and the concentration of hydrochloric acid in the etch solution is at least about 1.5 molar.

Embodiments disclosed herein also include those in which the concentration of hydrofluoric acid in the etch solution is at least about 1.5 molar and the concentration of hydrochloric acid in the etch solution is at least about 3 molar.

Embodiments disclosed herein also include those in which the concentration of hydrofluoric acid in the etch solution is at least about 1.5 molar and the concentration of hydrochloric acid in the etch solution is at least about 4.5 molar.

Embodiments disclosed herein also include those in which the concentration of hydrofluoric acid in the etch solution is at least about 1.5 molar and the concentration of hydrochloric acid in the etch solution is at least about 6 molar.

Embodiments disclosed herein also include those in which the concentration of hydrofluoric acid in the etch solution is at least about 1.5 molar and the concentration of hydrochloric acid in the etch solution is at least about 7.5 molar.

Embodiments disclosed herein also include those in which the concentration of hydrofluoric acid in the etch solution is at least about 3 molar and the concentration of hydrochloric acid in the etch solution is at least about 3 molar.

Embodiments disclosed herein also include those in which the concentration of hydrofluoric acid in the etch solution is at least about 3 molar and the concentration of hydrochloric acid in the etch solution is at least about 6 molar.

Embodiments disclosed herein also include those in which the concentration of hydrofluoric acid in the etch solution ranges from about 1.5 to about 6 molar and the concentration of hydrochloric acid in the etch solution ranges from about 1.5 to about 12 molar.

Embodiments disclosed herein also include those in which the concentration of hydrofluoric acid in the etch solution ranges from about 1.5 to about 6 molar and the concentration of hydrochloric acid in the etch solution ranges from about 3 molar to about 12 molar.

Embodiments disclosed herein also include those in which the concentration of hydrofluoric acid in the etch solution ranges from about 1.5 to about 6 molar and the concentration of hydrochloric acid in the etch solution ranges from about 4.5 molar to about 9 molar.

In certain exemplary embodiments disclosed herein, including embodiments described above, the etch solution may applied to an edge surface 166 of glass sheet 62 at a solution temperature of at least about 45° C., such as at least about 50° C., and further such as at least about 55° C. For example, the etch solution may be applied to an edge surface 166 of glass sheet 62 at a solution temperature ranging from about 45° C. to about 60° C., such as from about 50° C. to about 55° C.

In certain exemplary embodiments disclosed herein, including embodiments described above, the etch solution may applied to an edge surface 166 of glass sheet 62 for a time of at least about 30 seconds, such as at least about 60 seconds, and further such as at least about 90 seconds, including about 120 seconds. For example, the etch solution may be applied to an edge surface 166 of glass sheet 62 for a time ranging from about 30 seconds to about 120 seconds, such as from about 30 seconds to about 60 seconds.

Accordingly, embodiments disclosed herein include those in which the etch solution comprises hydrofluoric and hydrochloric acid, the concentration of the hydrofluoric acid in the etch solution is at least about 1.5 molar, the concentration of the hydrochloric acid in the etch solution is at least about 1.5 molar, and the etch solution is applied to an edge surface of a glass sheet at a solution temperature of at least about 45° C. and for a time of at least about 30 seconds.

Embodiments disclosed herein also include those in which the etch solution comprises hydrofluoric and hydrochloric acid, the concentration of the hydrofluoric acid in the etch solution is at least about 1.5 molar, the concentration of the hydrochloric acid in the etch solution is at least about twice the concentration of the hydrofluoric acid in the etch solution, and the etch solution is applied to an edge surface of a glass sheet at a solution temperature of at least about 45° C. and for a time of at least about 30 seconds.

Embodiments disclosed herein also include those in which the etch solution comprises hydrofluoric and hydrochloric acid, the concentration of the hydrofluoric acid in the etch solution is at least about 1.5 molar, the concentration of the hydrochloric acid in the etch solution is at least about three times the concentration of the hydrofluoric acid in the etch solution, and the etch solution is applied to an edge surface of a glass sheet at a solution temperature of at least about 45° C. and for a time of at least about 30 seconds.

Embodiments disclosed herein also include those in which the etch solution comprises hydrofluoric and hydrochloric acid, the concentration of the hydrofluoric acid in the etch solution is at least about 1.5 molar, the concentration of the hydrochloric acid in the etch solution is at least about four times the concentration of the hydrofluoric acid in the etch solution, and the etch solution is applied to an edge surface of a glass sheet at a solution temperature of at least about 45° C. and for a time of at least about 30 seconds.

Embodiments disclosed herein also include those in which the etch solution comprises hydrofluoric and hydrochloric acid, the concentration of the hydrofluoric acid in the etch solution is at least about 1.5 molar, the concentration of the hydrochloric acid in the etch solution is at least about five times the concentration of the hydrofluoric acid in the etch solution, and the etch solution is applied to an edge surface of a glass sheet at a solution temperature of at least about 45° C. and for a time of at least about 30 seconds.

Embodiments disclosed herein also include those in which the etch solution comprises hydrofluoric and hydrochloric acid, the concentration of the hydrofluoric acid in the etch solution is at least about 3 molar, the concentration of the hydrochloric acid in the etch solution is at least about twice the concentration of the hydrofluoric acid in the etch solution, and the etch solution is applied to an edge surface of a glass sheet at a solution temperature of at least about 45° C. and for a time of at least about 30 seconds.

Embodiments disclosed herein also include those in which the etch solution comprises hydrofluoric acid and hydrochloric acid, the concentration of the hydrofluoric acid in the etch solution is at least about 1.5 molar, the concentration of the hydrochloric acid in the etch solution is at least about 7.5 molar, and the etch solution is applied to an edge surface of a glass sheet at a solution temperature of at least about 45° C. and for a time of at least about 30 seconds.

Embodiments disclosed herein also include those in which the etch solution comprises hydrofluoric acid and hydrochloric acid, the concentration of the hydrofluoric acid in the etch solution is at least about 3 molar, the concentration of the hydrochloric acid in the etch solution is at least about 6 molar, and the etch solution is applied to an edge surface of a glass sheet at a solution temperature of at least about 45° C. and for a time of at least about 30 seconds.

Embodiments disclosed herein also include those in which the etch solution comprises hydrofluoric and hydrochloric acid, the concentration of the hydrofluoric acid in the etch solution ranges from about 1.5 molar to about 6 molar, the concentration of hydrochloric acid in the etch solution ranges from about 7.5 to about 12 molar, and the etch solution is applied to an edge surface of a glass sheet at a solution temperature ranging from about 45° C. to about 60° C. and for a time ranging from about 30 seconds to about 120 seconds.

Embodiments disclosed herein also include those in which the etch solution comprises hydrofluoric and hydrochloric acid, the concentration of the hydrofluoric acid in the etch solution ranges from about 3 molar to about 6 molar, the concentration of hydrochloric acid in the etch solution ranges from about 6 to about 12 molar, and the etch solution is applied to an edge surface of a glass sheet at a solution temperature ranging from about 45° C. to about 60° C. and for a time ranging from about 30 seconds to about 120 seconds.

In certain exemplary embodiments disclosed herein, including embodiments described above, the etch rate of the edge surface upon application of the etch solution may be at least about 2 micrometers per minute, such as at least about 3 micrometers per minute, and further such as at least about 4 micrometers per minute, and yet further such as at least about 5 micrometers per minute. For example, the etch rate of the edge surface upon application of the etch solution may range from about 2 micrometers per minute to about 20 micrometers per minute, including from about 4 micrometers per minute to about 10 micrometers per minute.

In certain exemplary embodiments at least 1 micrometer, such as at least 2 micrometers, and further such as at least 3 micrometers, and yet further such as at least 4 micrometers, and still yet further such as at least 5 micrometers, including from about 1 micrometer to about 5 micrometers of depth of the edge surface is etched away as a result of application of the etch solution.

The etch solution may be applied to the edge surface 166 by at least one of a number of methods including, for example, spraying, misting, dipping, rolling, and brushing.

In certain exemplary embodiments, an etch solution is not substantially applied to the first and second major surfaces 162, 164 of the glass article. Specifically, in such embodiments, the etch solution is only applied to the edge surfaces of the glass article, such as a glass sheet, and not to either of the major surfaces. Accordingly, embodiments disclosed herein include those in which an etch solution is applied to the edge surfaces of a glass article but the glass article, such as a glass sheet, is not thinned by chemical etching.

Embodiments disclosed herein are further illustrated by the following non-limiting examples. In the examples, a “gel-tack” method was used to analyze particle density on edge surfaces of glass articles. This method involves pressing the edge surface of the glass onto a piece of tacky gel to transfer particles onto the gel, taking images of the imprinted area of the gel under an optical microscope, and then analyzing the images to determine particle density.

### Example 1

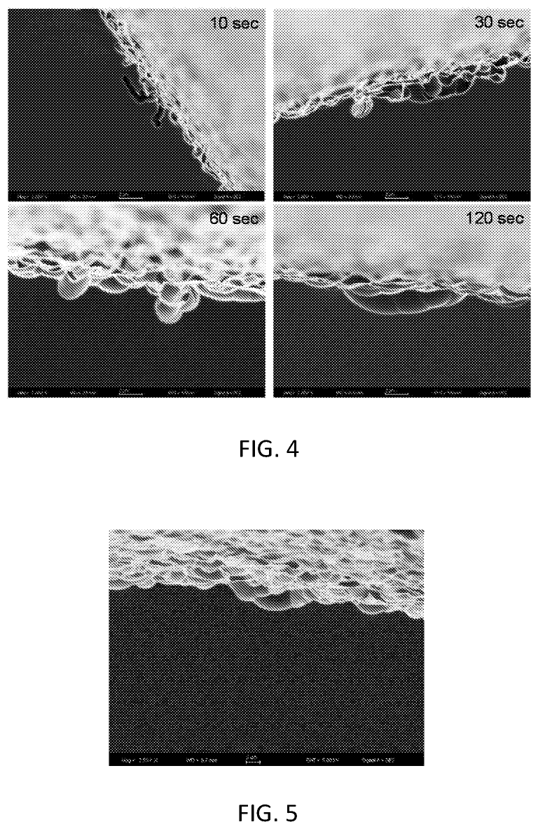

A series of Corning Lotus™ NXT glass samples were dipped in an aqueous solution of 1.5 molar hydrofluoric acid and 1.5 molar hydrochloric acid at 45° C. for various amounts of time ranging from 5 to 120 seconds. Subsequently, the samples were dipped in deionized water for 30 seconds, ultrasonicated in deionized water for 30 seconds, rinsed repeatedly in deionized water until pH neutral, and finally blown dry in nitrogen. Particle density determinations were then made according to the “gel-tack” method described above, with the results shown in Table 1. As can be seen from Table 1, as the treatment time was increased, the edge particle density progressively decreased. Further, as shown in FIG. 4, cross-section SEM images show that with increasing etch time, the edge morphology became smoother and surface and sub-surface damages were progressively removed. The sample treated for 120 seconds in particular showed a favorable edge morphology.

### Example 2

A series of Corning Lotus™ NXT glass samples were dipped in 1.5 molar hydrofluoric acid solutions with various hydrochloric acid concentrations. Table 1 shows that the major surface etch rate increased almost linearly with hydrochloric acid concentration. The etch rate was determined by sticking a piece of acid resistant masking tape on the flat surface of the glass before the chemical treatment and measuring the step height after the chemical treatment using a Zygo® NewView™ Optical Surface Profiler. Even though the etch rate on the major surface differs from the etch rate on the edge, the former provides a consistent metric for gauging the chemical strength of the etching formulation while the latter depends on not only the chemical formulation but also the edge morphology. Table 1 shows that the edge particle density decreased with increasing hydrochloric acid concentration. In particular, the edge treated in 1.5 molar hydrofluoric acid and 7.5 molar hydrochloric acid at 45° C. for 30 seconds had the lowest particle density and also showed a favorable edge morphology, as shown in FIG. 5.

### Example 3

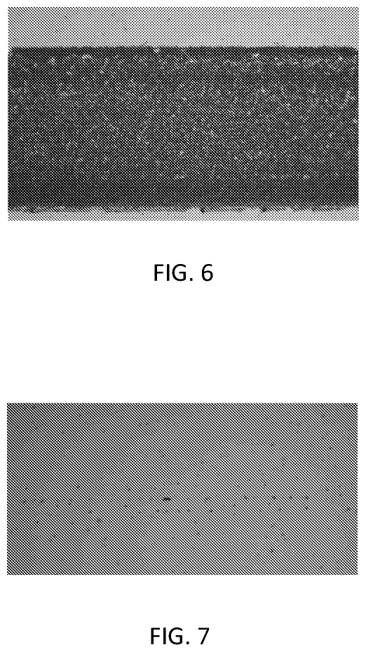

In this example, Corning Lotus™ NXT glass samples were dipped in a solution of 3 molar hydrofluoric acid and 3 molar hydrochloric acid at 45° C. for 30 seconds. Even though the etch rate was about 3 times that of the solution of 1.5 molar hydrofluoric acid and 1.5 molar hydrochloric acid at 45 C, the edge was heavily covered with reaction by-products as indicted by the black band in the gel-tack optical microscopy image shown in FIG. 6. Accordingly, a particle density measurement was not obtainable for this sample.

### Example 4

In this example, Corning Lotus™ NXT glass samples were dipped in a solution of 3 molar hydrofluoric acid and 6 molar hydrochloric acid at 45° C. for 30 seconds. The etch rate was nearly 5 times that of the solution of 1.5 molar hydrofluoric acid and 1.5 molar hydrochloric acid at 45° C. As shown in the gel-tack optical microscopy image of FIG. 7, the edge was substantially free of reaction by-products and had a relatively low particle count and a favorable morphology.

### Example 5

In this example, Corning Lotus™ NXT glass samples were dipped in 3 different etch solutions, specifically 1.5 molar hydrofluoric acid and 1.5 molar hydrochloric acid, 1.5 molar hydrofluoric acid and 7.5 molar hydrochloric acid, and 3 molar hydrofluoric acid and 6 molar hydrochloric acid, and each at 3 different temperatures (about 23° C., 45° C., and 60° C.). As can be seen in Table 1, relatively lower edge particle densities were achieved for etch solutions containing 1.5 molar hydrofluoric acid and 7.5 molar hydrochloric acid and etch solutions containing 3 molar hydrofluoric acid and 6 molar hydrochloric acid at 45° C. and 60° C.

TABLE 1

| | | Etch | Etch | Major Surface | Edge Surface | Edge Particle |
|---|---|---|---|---|---|---|
| | | Temp | Time | Etch Rate | Etch Rate | Count |
| Example | Etch Solution | (° C.) | (sec) | (μm/min) | (μm/min) | (#/mm²) |
| 1a | 1.5M HF/1.5M HCl | 45 | 5 | 1.17 | 2.92 | 1175 |
| 1b | 1.5M HF/1.5M HCl | 45 | 10 | 1.17 | 2.92 | 440 |
| 1c | 1.5M HF/1.5M HCl | 45 | 30 | 1.17 | 2.92 | 365 |
| 1d | 1.5M HF/1.5M HCl | 45 | 60 | 1.17 | 2.92 | 314 |
| 1e | 1.5M HF/1.5M HCl | 45 | 120 | 1.17 | 2.92 | 62 |
| 2a | 1.5M HF/1.5M HCl | 45 | 30 | 1.17 | 2.92 | — |
| 2b | 1.5M HF/3M HCl | 45 | 30 | 1.61 | — | 1007 |
| 2c | 1.5M HF/4.5M HCl | 45 | 30 | 2.33 | — | 652 |
| 2d | 1.5M HF/6M HCl | 45 | 30 | 2.35 | — | 286 |
| 2e | 1.5M HF/7.5M HCl | 45 | 30 | 2.88 | 7.54 | 164 |
| 3 | 3M HF/3M HCl | 45 | 30 | 3.48 | — | — |
| 4 | 3M HF/6M HCl | 45 | 30 | 5.71 | 12 | 64 |
| 5a | 1.5M HF/1.5M HCl | 23 | 30 | 0.76 | — | — |
| 5b | 1.5M HF/1.5M HCl | 45 | 30 | 1.17 | 2.92 | 365 |
| 5c | 1.5M HF/1.5M HCl | 60 | 30 | 1.99 | — | 403 |
| 5d | 1.5M HF/7.5M HCl | 23 | 30 | 1.27 | — | 1242 |
| 5e | 1.5M HF/7.5M HCl | 45 | 30 | 2.88 | 7.54 | 164 |
| 5f | 1.5M HF/7.5M HCl | 60 | 30 | 4.37 | — | 106 |
| 5g | 3M HF/6M HCl | 23 | 30 | 2.7 | — | 216 |
| 5h | 3M HF/6M HCl | 45 | 30 | 5.71 | 12 | 64 |
| 51 | 3M HF/6M HCl | 60 | 30 | 7.56 | — | 106 |

Embodiments disclosed herein include those in which the etch solution may be washed from the edge surface following its application to the edge surface. For example, the edge surface may be washed with at least one wash solution, which may comprise a liquid, such as water (e.g., deionized water), which may or may not include at least one component such as a detergent or surfactant.

In certain exemplary embodiments the glass article may be dipped in a wash solution, such as a wash solution agitated with, for example, ultrasonic energy. The glass article may also be washed with a wash solution applied with a mechanical action, such as with a brush.

Embodiments disclosed herein can enable glass articles, including glass sheets, with edge surfaces having reduced particle densities, such as less than about 200 per 0.1 square millimeter, while at the same time having favorably smooth surface morphologies with substantial removal of sub-surface damage caused by, for example, beveling processes. Accordingly, embodiments disclosed herein can not only provide an advantage of relatively low edge particle densities but can also provide an additional advantage of relatively smooth surfaces that are less susceptible to additional particle generation as a result of downstream processing steps. Embodiments disclosed herein also include those in which reaction by-products generated by application of the etch solution are removed.

While the above embodiments have been described with reference to a fusion down draw process, it is to be understood that such embodiments are also applicable to other glass forming processes, such as float processes, slot draw processes, up-draw processes, and press-rolling processes.

It will be apparent to those skilled in the art that various modifications and variations can be made to embodiment of the present disclosure without departing from the spirit and scope of the disclosure. Thus it is intended that the present disclosure cover such modifications and variations provided they come within the scope of the appended claims and their equivalents.

What is claimed is:

1. A method for manufacturing a glass article comprising:
forming the glass article, wherein the glass article comprises a first major surface, a second major surface parallel to the first major surface, and an edge surface extending between the first major surface and the second major surface in a perpendicular direction to the first and second major surfaces;
applying an etch solution to the edge surface of the glass article, wherein application of the etch solution reduces a density of particles on the edge surface to less than about 200 per 0.1 square millimeter.

2. The method of claim 1, wherein the etch solution comprises hydrofluoric acid and hydrochloric acid.

3. The method of claim 2, wherein the concentration of the hydrochloric acid in the etch solution is at least about twice the concentration of the hydrofluoric acid in the etch solution.

4. The method of claim 3, wherein the concentration of hydrofluoric acid in the etch solution is at least about 1.5 molar.

5. The method of claim 4, wherein the concentration of hydrofluoric acid in the etch solution ranges from about 1.5 molar to about 6 molar.

6. The method of claim 4, wherein the concentration of hydrochloric acid in the etch solution ranges from about 3 molar to about 12 molar.

7. The method of claim 3, wherein the concentration ratio of hydrochloric acid to hydrofluoric acid in the etch solution ranges from about 2:1 to about 6:1.

8. The method of claim 1, wherein an etch rate of the edge surface upon application of the etch solution is at least about 2 micrometers per minute.

9. The method of claim 8, wherein the etch rate of the edge surface upon application of the etch solution ranges from about 2 micrometers per minute to about 20 micrometers per minute.

10. The method of claim 1, wherein the step of applying further comprises applying the etch solution at a temperature of at least about 45° C.

11. The method of claim 10, wherein the step of applying further comprises applying the etch solution at a temperature ranging from about 45° C. to about 60° C.

12. The method of claim 1, further comprising beveling the edge surface prior to the step of applying the etch solution.

13. The method of claim 1, wherein the step of applying further comprises applying the etch solution by at least one method selected from the group consisting of spraying, misting, dipping, rolling, and brushing.

14. The method of claim 4, wherein the concentration of hydrochloric acid in the etch solution is at least about 7.5 molar.

15. The method of claim 4, wherein the concentration of hydrofluoric acid in the etch solution is at least about 3 molar.

16. A glass article made by the method of claim 1.

17. An electronic device comprising the glass article of claim 16.
